(19) United States
(12) Patent Application Publication
(10) Pub. No.: US 2013/0028725 A1
(43) Pub. Date: Jan. 31, 2013

(54) Resurfaced Wicket Gate and Methods

(71) Applicant: Jon E. Jacobsen, Stillwater, MN (US)

(72) Inventor: Jon E. Jacobsen, Stillwater, MN (US)

(21) Appl. No.: 13/559,981

(22) Filed: Jul. 27, 2012

Related U.S. Application Data
(60) Provisional application No. 61/512,622, filed on Jul. 28, 2011.

(51) Int. Cl. F03B 11/02; B23P 6/00

(52) U.S. Cl. 415/208.1; 29/888.021

(57) ABSTRACT

A method for refurbishing wicket gates by applying a sheet material to at least a portion of the vane surface of the wicket gate, thus forming a new face. This sheet material may be applied by wrapping the sheet material around the vane surface. The method may further include applying sheet material to the end surfaces of the wicket vane. If end material is applied, it may be sealed to the sheet material of the vane surface.

### RELATED APPLICATIONS

This application claims priority to U.S. provisional application 61/512,622 filed Jul. 28, 2011 titled “Wicket Gate and Methods”, the entire disclosure of which is incorporated herein.

### FIELD OF THE INVENTION

This invention generally relates to hydro electric equipment and refurbishing thereof. More specifically, this invention relates to hydro electric turbines.

### BACKGROUND OF THE INVENTION

The speed and torque of a hydro turbine is controlled by regulating the water flow into the turbine's runner/wheel. This water regulation is done with a set of wicket gates, which are vanes positioned in front of the turbine runner. Usually 12 to 24 wicket gates or vanes are equidistantly spaced in front of each runner. In use, the wicket gates pivot or rotate in unison to vary the opening between adjacent wickets gates, through which water flows into the turbine.

Many hydro turbines have been in services since before 1950, and many in service today are close to 100 years old. Over time, the surfaces of the wicket gates corrode, wear and erode due to the high velocity of the water passing through the gates; often, this water carries particulate contaminant that pits the surface of the gates. The wicket gates also corrode, further pitting the surface and creating more particulate contaminant. All surface imperfections affect the flow of the water past the wicket gates and through the turbine, detrimentally affecting the efficiency of the turbine.

When hydro units are serviced or rebuilt, the conventional practice is to clean and then coat the wicket gates with a paint or similar coating. Unfortunately, this typically still leaves a rough surface. Improvements are desired.

### BRIEF SUMMARY OF THE INVENTION

This invention is directed to a method that includes wrapping at least a portion of a wicket gate with a sheet material, such as metal, forming a new outer surface. The method can be used for the repair, resurfacing, or refacing of used, or even new, wicket gates.

In one particular embodiment, this disclosure provides a refurbished wicket gate for a hydro turbine, the wicket gate having a vane surface and first and second opposite end surfaces. The refurbished wicket gate has a sheet material present on or over at least a portion of the original vane surface. In some embodiments, the sheet material is metal, such as stainless steel, titanium, platinum, carbon steel, galvanized, nickel, etc. The thickness of the sheet material (e.g., metal, e.g., stainless steel) may be from about 0.0010 inch (10 mil) to 0.1 inch, although thicker and thinner materials may be suitable for some installations. The refurbished wicket gate may also have new material on its end surfaces. This new material on the end surfaces may be sealed to the sheet material on the vane surface, for example by welding, soldering or brazing. This new material of the end surfaces may be metal, such as stainless steel, with a thickness that could be about 0.0010 inch (10 mil) to 0.1 inch. In some embodiments, a thicker material is used for the end surfaces than the vane surface.

In another particular embodiment, this disclosure provides a method of servicing a wicket gate for a hydro turbine, the wicket gate having a vane surface and first and second opposite end surfaces. The method includes applying a sheet material over at least a portion of the vane surface of the wicket gate and sealing or seaming the sheet material. This material may be applied by wrapping the sheet material around the vane surface, for example, partially around the vane surface, once around the vane surface or more than once around the vane surface. The method may further include applying sheet material to the end surfaces of the wicket vane. If end material is applied, it may be sealed to the sheet material of the vane surface, for example, by welding, soldering or brazing.

These and various other features and advantages will be apparent from a reading of the following detailed description.

### BRIEF DESCRIPTION OF THE DRAWING

The invention may be more completely understood in consideration of the following detailed description of various embodiments of the invention in connection with the accompanying drawing, in which:

FIG. 1A is a front plan view of a wicket gate;

FIG. 1B is a side plan view of the wicket gate; and

FIG. 1C is a cross-sectional view of the wicket gate taken along line C-C.

### DETAILED DESCRIPTION

The present invention is directed to resurfacing wicket gates with material to provide a new exposed surface. In accordance with this invention, at least a portion of the wicket gate is wrapped or covered with a sheet material, such as stainless steel. The entire wicket gate may be resurfaced, or only the vane or only a portion of the vane, or only the sides (ends) of the gate. The resulting wicket gate has a new, clean surface that, when installed in a turbine, is more efficient than dirty (uncleaned) wicket gates and wicket gates having a rough surface.

Wrapping or resurfacing wicket gates provides corrosion protection, provides a smooth surface for water flow thereover, provides a better sealing surface to minimize water leakage past or around the gate, and provides a more durable surface to the wicket gate.

In the following description, reference is made to the accompanying drawing that forms a part hereof and in which are shown by way of illustration various specific embodiments. The description provides additional specific embodiments. It is to be understood that other embodiments are contemplated and may be made without departing from the scope or spirit of the present invention. The following detailed description, therefore, is not to be taken in a limiting sense. While the present invention is not so limited, an appreciation of various aspects of the invention will be gained through a discussion of the examples provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

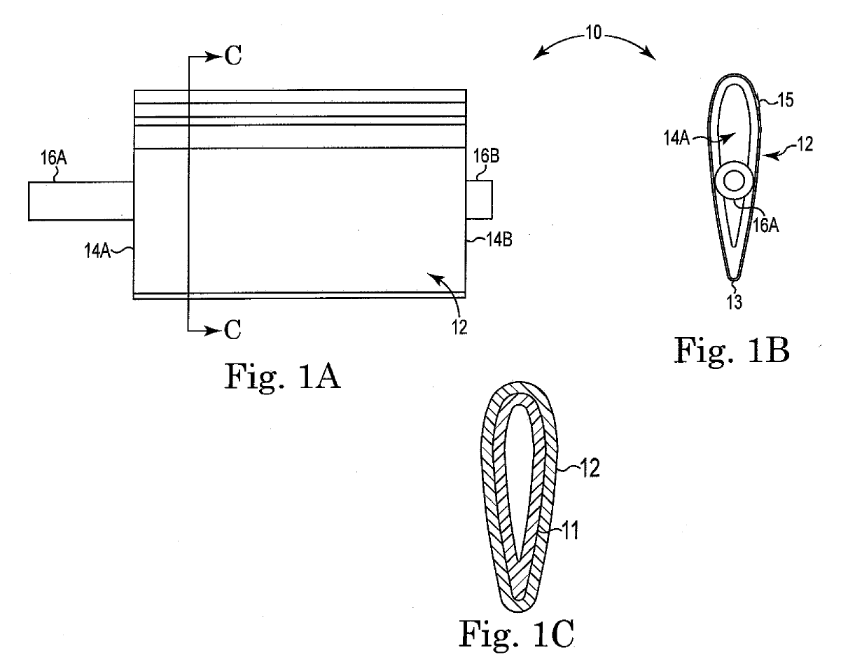

FIGS. 1A, 1B and 1C illustrate a wicket gate 10 that has been resurfaced in accordance with the present invention. Wicket gate 10 has an original vane surface 11 (best viewed in FIG. 1C) that provides a continuous surface around wicket gate 10. Wicket gate 10 includes two opposite ends 14A, 14B between which vane surface 11 extends. Best viewed in FIG. 1B, ends 14A, 14B have a generally tear-drop shape with radiused ends. Specifically, the shape of ends 14A, 14B has a larger radiused end, a smaller radiused end (i.e., trail or trailing edge 13), and generally flat though somewhat arcuate faces. Wicket gate 10 may have a pronounced and/or reinforced gate-to-gate sealing surface 15, which is the area that contacts the tail edge of the adjacent wicket gate when the gates are closed. Wicket gates having other shapes may also be resurfaced in accordance with this invention. FIGS. 1A and 1B illustrate each end 14A, 14B having a shaft 16A, 16B, respectively, which provides a mounting mechanism for gate 10 and an axis around which wicket gate 10 can rotate. In other embodiments, the wicket gate may instead have a bore (often referred to as a ‘through shaft’) into which a shaft can be inserted.

According to the present invention, vane surface 11 is resurfaced with a sheet good material positioned over and covering at least a portion of vane surface 11. See FIG. 1C. This new surface 12 is referred to herein as “clad”, “cladding”, or as “being clad”, although other terns such as “sleeve” can be used to describe the new surface 12 over the old vane surface 11. Ends 14A, 14B may also be resurfaced. In alternate embodiments, ends 14A, 14B and not vane surface 11 are resurfaced.

Vane surface 11, ends 14A, 14B or any other portion of wicket gate 10 may be cleaned prior to resurfacing, to reduce the surface pitting and irregularities, and to inhibit any further chemical degradation of gate 10.

Wicket gate 10, particularly surface 11, may be wrapped or resurfaced in any suitable sheet good material. Typically, this material will be a metal (including metal alloy), a polymeric (“plastic”), or a composite material (e.g., ceramic). The material may be reinforced, for example, by individual fibers or by fiber mesh. Stainless steel is a preferred material for wrapping vane surface 11, as stainless steel is highly resistant to corrosion, is tough, and is readily available. Stainless steel is also easily conformed to surface 11 and easily seamed (e.g., such as by welding). Typically, the same material will be applied to each of the surfaces 11, 14A, 14B being resurfaced, although this is not necessary. In some embodiments, a thinner material may be used on surfaces that are less exposed to water when in use, surfaces such as ends 14A, 14B.

The thickness of the sheet good material used for cladding 12 is typically at least 0.0005 inch (5 mil) and no more than about 0.2 inch, depending on the sheet material, wicket gate size, and working environment of the wicket gate. Too thick of material will increase the dimensions of the wicket gate and thus decrease the available water flow area past the wicket gate. Also, depending on the material, if the sheet material is overly thick it may be difficult to form around the wicket gate, whereas if the sheet material is too thin, it not have sufficient integrity to withstand the high water forces over time. It is not necessary that the same thickness material be used on all surfaces being resurfaced. For example, it may be desired to use a thicker material on ends 14A, 14B than on vane surface 11. A stainless steel thickness of about 0.0010 inch (10 mil) to 0.1 inch is suitable for applying to vane surface 11 and a thickness of about 0.0010 inch (10 mil) to 0.1 inch is suitable for applying to ends 14A, 14B, although in some embodiments a thicker material is desired for ends 14A, 14B than for vane surface 11. It is not uncommon for the sheet material to slightly distort in thickness (e.g., thin) upon application to vane surface 11, due to the radiused and arcuate surface around which the material is wrapped.

The sheet material may be a distinct sheet or a seamless sleeve or tube prior to placing on vane surface 11. An example seamless sleeve is a “heat shrinkable” material. Such a structure would eliminate seams in the resulting new surface 12, minimizing the possibility of leaking and thus introducing water behind surface 12. In some embodiments, a single sheet of sheet material is preferred to wrap or resurface vane surface 11, due to its ease of application on vane surface 11. When a single sheet of material is used around vane surface 11, a preferred location for the seam is at or proximate to trail edge 13. However, multiple sheets could be used to wrap or resurface vane surface 11, resulting in multiple seams. As an example when multiple sheets or pieces of material are used around vane surface 11, preferred locations for the seam are at or proximate to trail edge 13 and at or proximate to gate-to-gate sealing surface 15. In some embodiments, only a portion of vane surface 11 is covered; in such embodiments, the covered surface 12 would be the portion of gate 10 that is exposed to the highest water forces when in use.

In some embodiments, a reinforcing member may be present on or under surface 12 in locations that exposed to high water forces. For example, either or both tail end 13, which experiences large amounts of turbulence, and gate-to-gate sealing surface 15 (see FIG. 1B), which is a potential physical contact area between wicket gate 10 and an immediately adjacent gate, may include reinforcement. An example of a reinforcing member is a solid stainless steel rod, bar or plate (e.g., about ½ to 1 inch wide). To facilitate attachment of the reinforcing member, the reinforcing member may be recessed into surface 11 or surface 12. For example, a groove may be machined into surface 11 to receive the reinforcing member. Having a seam in the sheet material forming surface 12 facilitates including a reinforcing member, because a reinforcing member can readily be positioned at a seam location, such as at trail edge 13 or gate-to-gate sealing surface 15.

After or while wrapping vane surface 11 with the sheet material, the material may be attached to surface 11 by welding, soldering, brazing, adhesive, riveting or other mechanical fastener, etc. the material directly onto surface 11. In some embodiments, multiple attachment mechanisms (e.g., welding and adhesive) may be used. Alternately, the material may be left ‘floating’ on the old surface, with only the edges of the sheet material ends being seamed and sealed, for example, at trail edge 13. In some embodiments, the material may be both attached to surface 11 and seamed. The seam formed between the two ends of the sheet material may be sealed, for example, by welding, soldering, brazing, adhesive, riveting, etc. Preferably, the sheet material is attached over vane surface 11 in a manner so that little or no water gains access to behind the material. Thus, the side edges of the sheet material are also preferably sealed.

In some embodiments, wicket gate ends 14A, 14B may additionally be resurfaced with sheet material to form a new surface. Similar to the vane surface 11, the material may be attached to the existing (old) ends by welding, soldering, brazing, adhesive, riveting, etc. Alternately, the material may be left ‘floating’ on the old end surfaces, the sheet material ends merely being seamed, for example, to the side edges of the material resurfacing vane surface 11. In some embodiments, the material may be both attached to the end surface and seamed. Preferably, the sheet material is attached to ends 14A, 14B so that little or no water gains access to behind the material. The seal between the two ends and the side edges of the sheet material of surface 11 may be sealed, for example, by welding, soldering, brazing, adhesive, etc.

Similarly, if present, shafts 16A, 16B can be covered, the material being attached to ends 14A, 14B via welding, soldering, brazing, adhesive, etc. For embodiments where a shaft is not present but a bore exists, the surface of the bore can be covered, for example, with a tube slid into the bore.

Depending on the attachment mode of the sheet material to vane surface 11 (and optionally to ends 14A, 14B, shafts 16A, 16B, etc.), the sheet material may be removable from wicket gate 10. This may be desirable for installations where the environment is extremely damaging to the wicket gate and refurbishing of the wicket gates is done frequently. At the second and subsequent services, the sheet material may be removed from the vane surface and replaced with a new sheet or sleeve of material. Similarly, the sheet material may be removed from the ends and replaced with new material. This would be desirable in installations where the dimensions of wicket gate 10 are fairly critical.

Thus, embodiments of RESURFACED WICKET GATE AND METHODS are disclosed. Various modifications and alterations of this invention will become apparent to those skilled in the art without departing from the scope and spirit of this invention, and it should be understood that this invention is not to be unduly limited to the illustrative embodiments set forth herein. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A wicket gate for a hydro turbine, the wicket gate having a vane surface and first and second opposite end surfaces, at least a portion of the vane surface or the end surfaces having a sheet material thereon.

2. The wicket gate of claim 1 wherein the entire vane surface has the sheet material thereon.

3. The wicket gate of claim 1 wherein the entire vane surface and the end surfaces have sheet material thereon.

4. The wicket gate of claim 1 wherein the sheet material is metal.

5. The wicket gate of claim 4 wherein the sheet material is stainless steel.

6. The wicket gate of claim 1 wherein the sheet material has a thickness of 0.001 inch to 0.1 inch.

7. The wicket gate of claim 2 wherein the sheet material has a seam at a trail edge of the vane surface.

8. The wicket gate of claim 7 wherein the seam is formed by welding, brazing, adhesive, or screws, or rivets.

9. The wicket gate of claim 7 further comprising a reinforcing member at the seam.

10. The wicket gate of claim 3 wherein the sheet material on the end surfaces is sealed to the sheet material on the vane surface by welding, brazing or adhesive.

11. A wicket gate for a hydro turbine, the wicket gate having an arcuate vane surface and a trail edge, and first and second opposite end surfaces, a stainless steel cover over at least a portion of the arcuate vane surface.

12. The wicket gate of claim 11 wherein the stainless steel cover is over the entire arcuate vane surface.

13. The wicket gate of claim 11 wherein the stainless steel cover is over the entire arcuate vane surface and the first and second opposite end surfaces.

14. A method of servicing a wicket gate for a hydro turbine, the wicket gate having a vane surface, a trail edge, and first and second opposite end surfaces, the method comprising applying a sheet material to the vane surface of the wicket gate and attaching the sheet material to the wicket gate.

15. The method of claim 14 wherein applying the sheet material to the vane surface comprises wrapping the sheet material around the vane surface.

16. The method of claim 15 wherein the sheet material is seamed at the trail edge.

17. The method of claim 14 further comprising applying sheet material to the end surfaces of the wicket vane.

18. The method of claim 17 further comprising sealing the sheet material of the end surfaces to the sheet material of the vane surface.
